(19) United States
(12) Patent Application Publication
(10) Pub. No.: US 2006/0269090 A1
(43) Pub. Date: Nov. 30, 2006

(54) Supra-aural headphone noise reducing

(76) Inventor: Roman Sapiejewski, Boston, MA (US)

Correspondence Address: FISH & RICHARDSON PC, P.O. BOX 1022, MINNEAPOLIS, MN, 55440-1022, US

(21) Appl. No.: 11/139,045

(22) Filed: May 27, 2005

(51) Int. Cl. H04R 25/00

(52) U.S. Cl. 381/371

(57) ABSTRACT

An earphone for a supra-aural noise reducing headphone, with a front cavity that includes a foam portion and an open passageway. The foam portion supplements the volumetric dimension of the passageway.

The present invention relates in general to supra-aural headphoning and more particularly to supra-aural headphone noise reducing.

### BACKGROUND OF THE INVENTION

For background reference is made to U.S. Pat. Nos. 6,567,525 and 6,894,835.

### SUMMARY OF THE INVENTION

In one aspect of the invention an earphone for a supra-aural headphone earphone includes a cup-shaped shell and a cushion mounted to the shell. The cushion includes a portion of an acoustically open foam having an inside surface and an outside surface, the inside surface defining and acoustically coupled to a passageway having a cross-sectional area and a passageway volumetric dimension. The earphone also includes a cushion cover of high acoustic impedance material enclosing a portion of the outside surface of the portion of acoustically open foam, wherein the cushion cover and the shell define an interior enclosed volume having a volumetric dimension. The earphone further includes a baffle assembly, including a baffle plate mounting an acoustic driver having a diaphragm. The baffle assembly is mounted in the earphone to divide the interior enclosed volume into a front enclosed volume portion and a rear enclosed volume portion. The front enclosed volume portion includes the passageway and the acoustically open foam. The volumetric dimension of the front enclosed volume is greater than 10 cc and the passageway volumetric dimension is less than 10 cc. The earphone is constructed and arranged to be positioned against the ear of a user so that the passageway acoustically couples the diaphragm to the user's ear canal.

The passageway cross-sectional area may be smaller than the acoustic driver radiating surface area. The volumetric dimension of the front volume may be about 25 cc, and the passageway volumetric dimension may be about 5 cc. The acoustically open foam may be a fully reticulated, slow recovery material. The rear enclosed volume portion may be acoustically coupled to the environment by an acoustic mass and an acoustic resistance in parallel. The passageway may have an elongated cross-sectional shape.

In another aspect of the invention, an earphone for an active noise reduction headphone, includes a generally planar baffle having two surfaces, with an opening therethrough; a first enclosed volume portion, that includes the first baffle surface, a foam structure having two generally planar surfaces and sides and an opening therethrough. The opening has two ends. The first planar surface of the foam structure is mounted against the first baffle surface so that the baffle opening may be adjacent the first end of the cushion opening. The foam structure opening may be acoustically coupled to the foam structure. The earphone may further include a cushion cover of acoustically closed material, covering the second planar surface of the foam structure, except for the second end of the cushion opening. The earphone may also include a second enclosed volume portion that includes the second baffle surface, and a cup-shaped shell. The cushion cover may be constructed and arranged to seal against the external portion of a user's ear.

The earphone may further include an acoustic driver, mounted in the baffle opening. The volumetric dimension of the cushion passageway may be less than 10 cc. The volumetric dimension of the cushion passageway may be about 5 cc. The volumetric dimension of the foam structure may be about 20 cc. The rear enclosed volume portion may be acoustically coupled to the environment by an acoustic volume and an acoustic resistance in parallel. The foam structure opening may have an elongated shape in cross section. The foam structure opening may have a racetrack shape in cross section. The foam structure planar surfaces may have an elongated shape. The foam structure planar surfaces may have an oval shape.

In yet another aspect of the invention, an earphone for an active noise reduction headphone, includes an acoustic driver, a volume having a volumetric dimension, enclosed by high acoustical impedance material, acoustically coupling the acoustic driver and a user's ear and sealed to the user's ear. The earphone also has an open passageway between the acoustic driver and the ear inside the volume. The open passageway has a volumetric dimension. The earphone also has a portion of substantially acoustically open foam in the volume. The foam has a volumetric dimension. The foam is acoustically coupled to the passageway so that the volumetric dimension of the foam significantly acoustically increases the volumetric dimension of the passageway to better passively attenuate noise that enters the volume. The foam volumetric dimension is greater than the passageway volumetric dimension. The foam volumetric dimension may be more than twice the volumetric dimension of the passageway. The foam volumetric dimension may be more than four times the volumetric dimension of the passageway. The volumetric dimension of the foam may be 25 cc and the volumetric dimension of the passageway may be 5 cc.

Other features, objects, and advantages will become apparent from the following detailed description, when read in connection with the following drawing, in which:

### BRIEF DESCRIPTION OF THE SEVERAL VIEWS OF THE DRAWING

FIG. 1 is a front plan view of a supra-aural headphone;

FIGS. 2A and 2B are cross-sectional views of an earphone; and

FIG. 3 is an inside plan view of an earphone.

### DETAILED DESCRIPTION

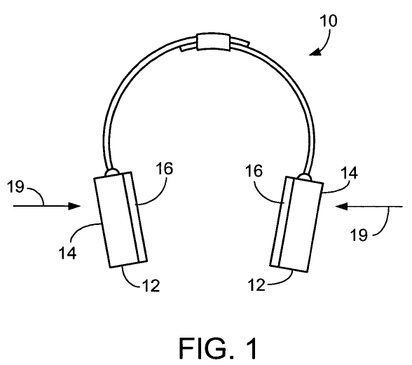

Referring to FIG. 1, there is shown a supra-aural headphone 10. The headphone includes two earphones 12, connected by a headband. Each earphone 12 includes a cup shaped shell 14 and a cushion 16. The headband 17 exerts a force in an inward direction as represented by arrows 19.

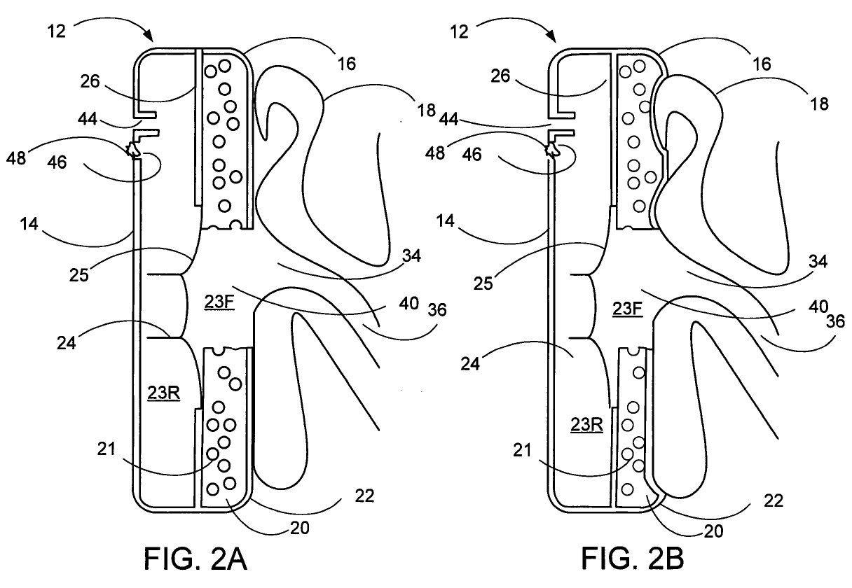

FIGS. 2A and 2B show a side cross-sectional view of an earphone 12 in position against a user's ear. The cushion 16 deforms slightly (FIG. 2B) to form a seal against the user's ear 18. The seal significantly reduces the amplitude of external acoustic energy reaching the concha 34 and the ear canal 36 of the user.

The cushion 16 includes a foam portion 20 and a cushion cover 22. Foam portion 20 is made of a type of foam that is acoustically open, that is, it is capable of propagating pressure waves. A suitable type of foam is a fully reticulated, slow recovery foam such as CFNT foam, supplied by the E-A-R Specialty Composites business unit of Aeraro Company of Indianapolis, Ind. Air cells 21 are shown to indicate that the material is foam but do not represent actual structure of the foam. The shell portion 14 may be made of a rigid plastic having high acoustic impedance, such as an ABS plastic. Together, the shell 14 and the cushion cover enclose an interior volume 23.

An acoustic driver 24 is mounted in a baffle 26. The acoustic driver 24 includes a diaphragm 25. Baffle 26 and diaphragm 25 separate the enclosed internal volume 23 into a front enclosed volume portion 23F and a rear enclosed volume portion 23R. The front enclosed volume portion includes a passageway 40 that acoustically couples diaphragm 25 to concha 34 and ear canal 36 of the user's ears without creating a significant pressure gradient between the ear and the diaphragm. Foam portion 20 is acoustically coupled to the passageway 40 and is sufficiently acoustically open that it volumetrically supplements the passageway 40 and therefore increases the volumetric dimension of front enclosed volume portion 23F. The volumetric dimension of foam portion 20 is greater, and preferably much greater, for example greater than four times, the volumetric dimension of passageway 40. In one embodiment, the total volumetric dimension of the front enclosed volume portion may be in the range of 30 cc, of which 5 cc is passageway 40 and 25 cc is foam portion 20 Passageway 40 may have a smaller cross-sectional area than diaphragm 25. Cushion cover 22 has high acoustic impedance, so sound waves passing through the cushion cover are significantly attenuated. The cushion cover 22 forms a seal with a user's ear and forms a portion of a boundary of the enclosed acoustic volume 23. A suitable material for the cushion cover is protein leather. The opening 42 between the passageway and concha 34 may be covered with an acoustically transparent material to protect the diaphragm and to prevent debris from entering the interior of the earphone. The rear enclosed volume portion 23R may be acoustically coupled to the environment by an acoustic mass, such as acoustic port 44 and an acoustically resistive opening 46, as described in U.S. Pat. No. 6,894,835. The acoustic resistance in the acoustically resistive opening could be a portion of polyester material, as shown in FIGS. 2A and 2B, or may be a wire mesh, or some other acoustically resistive material.

An earphone in which the foam acoustically open to the passageway, supplements the volumetric dimension of the passageway, and is greater, preferably significantly greater, than the volumetric dimension of the passageway is advantageous because the front enclosed volume can be larger than the front enclosed volume of conventional headphones, while still providing a large compliant surface to provide a good seal with the ear. Such an earphone is especially advantageous for supra-aural headphones, because the earphone can be made relatively small while having the large front enclosed volume for passive noise attenuation and the large compliant sealing surface.

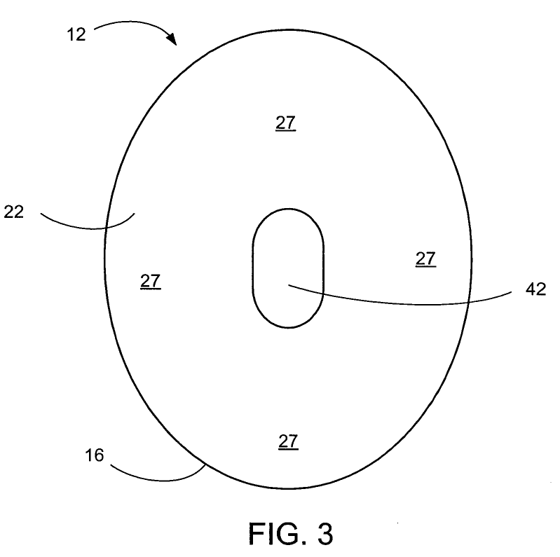

FIG. 3 shows a plan view of the earphone 12 of FIG. 2, The foam portion and the cushion cover 22 provide a substantially flat area 27 that seals against the ear of the user. The flat area 27 is sufficiently large so that the earphone provides a good seal against a wide variety of different ear shapes, sizes, and contours. The earphone cushion 16 and the opening 42 have an elongated shape, such as an oval shape or a “racetrack” (two semicircles connected by substantially straight lines) shape. The oval or racetrack shapes match the typical shape of the human ear and the concha better than do earphones having circularly shaped openings.

Numerous uses of and departures from the specific apparatus and techniques disclosed herein may be made without departing from the inventive concepts. Consequently, the invention is to be construed as embracing each and every novel feature and novel combination of features disclosed herein and limited only by the spirit and scope of the appended claims.

What is claimed is:

1. An earphone for a supra-aural headphone comprising:
a cup-shaped shell;
a cushion mounted to the shell and comprising a portion of an acoustically open foam having an inside surface and an outside surface, the inside surface defining and acoustically coupled to a passageway having a cross-sectional area and a volumetric dimension;
a cushion cover of a high acoustic impedance material enclosing a portion of the outside surface of the portion of acoustically open foam, wherein the cushion cover and the shell define an interior volume having a volumetric dimension;
a baffle assembly, comprising a baffle plate and an acoustic driver having a diaphragm and radiating surface area, mounted in the baffle plate, the baffle assembly mounted in the earphone to divide the interior enclosed volume into a front enclosed volume portion and a rear enclosed volume portion, the front enclosed volume portion comprising the passageway and the foam, wherein the volumetric dimension of the front enclosed volume is greater than 10 cc and the volumetric dimension of the passageway is less than 10 cc,
wherein the earphone is constructed and arranged to be positioned against the ear of a user so that the passageway acoustically couples the diaphragm to the user's ear canal.

2. An earphone in accordance with claim 1 wherein the passageway cross-sectional area is smaller than the acoustic driver radiating surface area.

3. An earphone in accordance with claim 1 wherein the volumetric dimension of the front volume is about 25 cc and the volumetric dimension of the passageway is about 5 cc.

4. An earphone in accordance with claim 1 wherein the foam comprises a fully reticulated, slow recovery material.

5. An earphone in accordance with claim 1 wherein the rear enclosed volume portion is acoustically coupled to the environment by an acoustic mass and an acoustic resistance in parallel.

6. An earphone in accordance with claim 1 wherein the passageway has an elongated cross-sectional shape.

7. An earphone for an active noise reduction headset comprising:
a generally planar baffle having first and second baffle surfaces with an opening therethrough;
a first enclosed volume portion comprising the first baffle surface;
a foam structure having first and second generally planar surfaces and sides and an opening therethrough, the opening having two ends, the first planar surface of the foam structure mounted against the first baffle surface so that the baffle opening is adjacent the first end of the cushion opening with the foam structure opening acoustically coupled to the foam structure;
a cushion cover of acoustically closed material, covering the second planar
surface of the foam structure, except for the second end of the cushion opening;
a second enclosed volume portion comprising the second baffle surface; and
a cup-shaped shell;
wherein the cushion cover is constructed and arranged to seal against the external portion of a user's ear.

8. An earphone in accordance with claim 7 and further comprising an acoustic driver, mounted in the baffle opening.

9. An earphone in accordance with claim 7 wherein the volumetric dimension of the cushion passageway is less than 10 cc.

10. A earphone in accordance with claim 9 wherein the volumetric dimension of the cushion passageway is about 5 cc.

11. An earphone in accordance with claim 9 wherein the volumetric dimension of the foam structure is about 20 cc.

12. An earphone in accordance with claim 7 wherein the rear enclosed volume portion is acoustically coupled to the environment by an acoustic volume and an acoustic resistance in parallel.

13. An earphone in accordance with claim 7 wherein the foam structure opening has an elongated shape in cross section.

14. An earphone in accordance with claim 13 wherein the foam structure opening has a racetrack shape in cross section.

15. An earphone in accordance with claim 7 wherein the foam structure planar surfaces have an elongated shape.

16. An earphone in accordance with claim 15 wherein the foam structure planar surfaces have an oval shape.

17. An earphone for an active noise reduction headset, comprising:
an acoustic driver;
a high acoustical impedance material enclosing a volume having a volumetric dimension, constructed and arranged to acoustically couple the acoustic driver and a user's ear and be sealed to the user's ear;
an open passageway constructed and arranged to be between the acoustic driver and the ear inside the volume, the open passageway having a volumetric dimension;
a portion of substantially acoustically open foam in the volume, the foam having a volumetric dimension, and acoustically coupled to the passageway so that the volumetric dimension of the foam significantly acoustically increases the volumetric dimension of the passageway to better passively attenuate noise that enters the volume;
wherein the foam volumetric dimension is greater than the passageway volumetric dimension.

18. An earphone in accordance with claim 17 wherein the foam volumetric dimension is more than twice the volumetric dimension of the passageway

19. An earphone in accordance with claim 18 wherein the foam volumetric dimension is more than four times the volumetric dimension of the passageway.

20. An earphone in accordance with claim 17 wherein the volumetric dimension of the foam is 25 cc and the volumetric dimension of the passageway is 5 cc.
